(19) United States
(12) Patent Application Publication
(10) Pub. No.: US 2025/0325934 A1
(43) Pub. Date: Oct. 23, 2025

(54) LIQUID DESICCANT ENHANCED MOISTURE SWING SYSTEM

(71) Applicant: BLUE FRONTIER INC., Boca Raton, FL (US)

(72) Inventors: Matthew TILGHMAN, Pennington, NJ (US); Daniel A. BETTS, Parkland, FL (US)

(73) Assignee: BLUE FRONTIER INC., Boca Raton, FL (US)

(21) Appl. No.: 19/182,739

(22) Filed: Apr. 18, 2025

Related U.S. Application Data
(60) Provisional application No. 63/637,631, filed on Apr. 23, 2024.

(51) Int. Cl. B01D 53/04; B01D 53/26

(52) U.S. Cl. CPC B01D 53/04; B01D 53/263; B01D 53/265; B01D 2257/504; B01D 2257/80

(57) ABSTRACT

A moisture swing system including a moisture swing housing including a moisture swing material and a liquid desiccant (LD) regenerator is provided. The LD regenerator is adapted to contact a low concentration liquid desiccant (LCLD) stream with a dry CO₂ feed stream, where moisture from the LCLD stream is transferred into the CO₂ feed stream as water vapor to form a high concentration liquid desiccant (HCLD) stream and a wet CO₂ feed stream. The wet CO₂ stream is contacted with the moisture swing material to form a wet, concentrated CO₂ stream that exits the moisture swing housing. The system can also include a LD conditioner adapted to produce a dry CO₂-rich target stream to contact with the moisture swing material. The LD conditioner and the LD regenerator can be connected to produce a closed-loop system that uses and regenerates the LD used in the moisture swing system.

### PRIORITY CLAIM AND CROSS-REFERENCE

This application claims priority under 35 U.S.C. 119 (e) to U.S. Provisional Application No. 63/637,631, filed Apr. 23, 2024, the entirety of which is incorporated herein by reference.

### FIELD OF THE INVENTION

The disclosure relates to moisture swing systems for capturing carbon dioxide. In particular, a moisture swing system that includes an integrated liquid desiccant systems for preparing feed streams used in the moisture swing system.

### BACKGROUND

Moisture swing systems have been used for capturing carbon dioxide.

### SUMMARY OF THE INVENTION

The present disclosure provides a moisture swing system, comprising a moisture swing housing comprising a moisture swing material; and a liquid desiccant (LD) regenerator adapted to contact a low concentration liquid desiccant (LCLD) stream with a dry CO₂ feed stream. In the system, moisture from the LCLD stream is transferred into the CO₂ feed stream as water vapor to form a high concentration liquid desiccant (HCLD) stream and a wet CO₂ feed stream; and the wet CO₂ stream is fed into the moisture swing housing to contact the moisture swing material and form a wet, concentrated CO₂ stream that exits the moisture swing housing.

In another aspect, a moisture swing system is provided that includes a moisture swing housing comprising a moisture swing material; and a liquid desiccant (LD) conditioner adapted to contact a CO₂-rich target stream with a high concentration liquid desiccant (HCLD) stream. In the system, moisture from the CO₂-rich target stream is absorbed by the HCLD stream to form a low concentration liquid desiccant (LCLD) stream and a dry CO₂-rich target stream; and the dry CO₂-rich target stream is fed into the moisture swing housing to contact the moisture swing material and form a dry, low CO₂ exhaust stream that exits the moisture swing housing.

In yet another aspect, a moisture swing system is provided that includes a moisture swing housing comprising a moisture swing material; a liquid desiccant (LD) regenerator adapted to contact a low concentration liquid desiccant (LCLD) stream with a dry CO₂ feed stream; and a liquid desiccant (LD) conditioner adapted to contact a CO₂-rich target stream with a high concentration liquid desiccant (HCLD) stream. In the system, moisture from the LCLD stream is transferred into the CO₂ feed stream as water vapor to form a high concentration liquid desiccant (HCLD) stream and a wet CO₂ feed stream; and the wet CO₂ stream is fed into the moisture swing housing to contact the moisture swing material and form a wet, concentrated CO₂ stream that exits the moisture swing housing. In the system, moisture from the CO₂-rich target stream is absorbed by the HCLD stream to form a low concentration liquid desiccant (LCLD) stream and a dry CO₂-rich target stream; and the dry CO₂-rich target stream is fed into the moisture swing housing to contact the moisture swing material and form a dry, low CO₂ exhaust stream that exits the moisture swing housing.

### BRIEF DESCRIPTION OF THE DRAWINGS

The present disclosure is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like reference numerals denote like features throughout specification and drawings.

FIG. 1 is a diagram of a moisture swing system including an integrated liquid desiccant system.

FIG. 2 is a diagram of a moisture swing system including an integrated liquid desiccant system and a recirculated carbon dioxide stream.

FIG. 3A is a diagram of a moisture swing system including an integrated liquid desiccant system and a moisture swing housing with a wet side and a dry side.

FIG. 3B is a diagram of a moisture swing system including an integrated liquid desiccant system, having a stratified desiccant storage tank, and a moisture swing housing with a wet side and a dry side.

FIG. 4 is a diagram of a moisture swing system including an integrated liquid desiccant system that uses thermal recapture to preheat a dry carbon dioxide feed stream.

FIG. 5 is a diagram of a moisture swing system including an integrated liquid desiccant system that uses thermal recapture to preheat a low concentration liquid desiccant feed stream.

FIG. 6 is a diagram of a moisture swing system including an integrated liquid desiccant system that incorporates a diluent and uses thermal recapture to preheat a dry carbon dioxide feed stream.

FIG. 7 is a diagram of a moisture swing system including an integrated liquid desiccant system that incorporates a diluent and uses thermal recapture to preheat a dry carbon dioxide feed stream.

FIG. 8 is a diagram of a moisture swing system including an integrated liquid desiccant system that uses an external heat sink to preheat a dry carbon dioxide feed stream.

FIG. 9 is a diagram of a moisture swing system including an integrated liquid desiccant system that uses thermal recapture to cool the liquid desiccant conditioner.

FIG. 10 is a diagram of a moisture swing system including an integrated liquid desiccant system that uses a boiling regenerator to remove carbon dioxide from the moisture swing material.

FIG. 11 is a diagram of a moisture swing system including an integrated liquid desiccant system that uses a boiling regenerator to remove carbon dioxide from the moisture swing material and includes thermal recapture to preheat the water vapor feed stream fed to the moisture swing housing.

FIG. 12 is a diagram showing a rotating plate for continuously moving moisture swing materials between a dry side and a wet side of a moisture swing housing.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

For purposes of the description hereinafter, it is to be understood that the embodiments described below may assume alternative variations and embodiments. It is also to be understood that the specific articles, compositions, and/or processes described herein are exemplary and should not be considered as limiting.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, clements, attributes, or steps are listed as alternatives or whether they are recited in isolation.

The present disclosure provides a moisture swing housing comprising a moisture swing material and a liquid desiccant (LD) regenerator. The LD regenerator can be adapted to contact a low concentration liquid desiccant (LCLD) stream with a dry CO₂ feed stream, where moisture from the LCLD stream is transferred into the CO₂ feed stream as water vapor to form a high concentration liquid desiccant (HCLD) stream and a wet CO₂ stream. The wet CO₂ stream can be fed into the moisture swing housing to contact the moisture swing material and extract CO₂ from the moisture swing material and form a wet, concentrated CO₂ stream that exits the moisture swing housing. As used herein, “wet, concentrated CO₂ stream” is used to reference the CO₂ stream exiting a wet portion of the moisture swing housing (e.g., the wet side or during wet operation).

The present disclosure also provides a moisture swing system, comprising a moisture swing housing comprising a moisture swing material and a liquid desiccant (LD) conditioner. The LD conditioner can be adapted to contact a CO₂-rich target stream with a high concentration liquid desiccant (HCLD) stream, where moisture from the CO₂-rich target stream is absorbed by the HCLD stream to form a low concentration liquid desiccant (LCLD) stream and a dry CO₂-rich target stream. The dry CO₂-rich target stream can be fed into the moisture swing housing to contact the moisture swing material (e.g., deposit CO₂ into the moisture swing material) and form a dry, low CO₂ exhaust stream that exits the moisture swing housing. As used herein, “dry, low CO₂ exhaust stream” is used to reference the CO₂ stream exiting a dry portion of the moisture swing housing (e.g., the dry side or during dry operation).

The present disclosure also provides for a moisture swing system that includes the LD regenerator, the LD conditioner, and the associated systems described herein. Such a system can be used to remove CO₂ from a CO₂-rich target stream and transfer the CO₂ to a wet, concentrated CO₂ stream. The wet, concentrated CO₂ stream can be disposed of in an environmentally friendly manner to minimize and/or reduce the presence of CO₂, which is a greenhouse gas, in the atmosphere.

In some embodiments, the moisture swing materials are adapted to adsorb CO₂ from a CO₂-rich target stream when the moisture swing materials are dry, and release CO₂ when the moisture swing materials are in a moist environment. The CO₂ adsorbed by the moisture swing material can then be extracted and disposed of in an environmentally friendly manner. In some embodiments, the CO₂-rich target stream can be air. In some embodiments, the CO₂-rich target stream can be an exhaust stream from a process, such as an industrial process, that produces CO₂.

The moisture swing systems described herein are adapted to utilize liquid desiccant systems to facilitate and enhance the use of moisture swing materials. In addition, such systems allow for energy storage and the shift of energy demand to times when there is less demand on the associated energy grid.

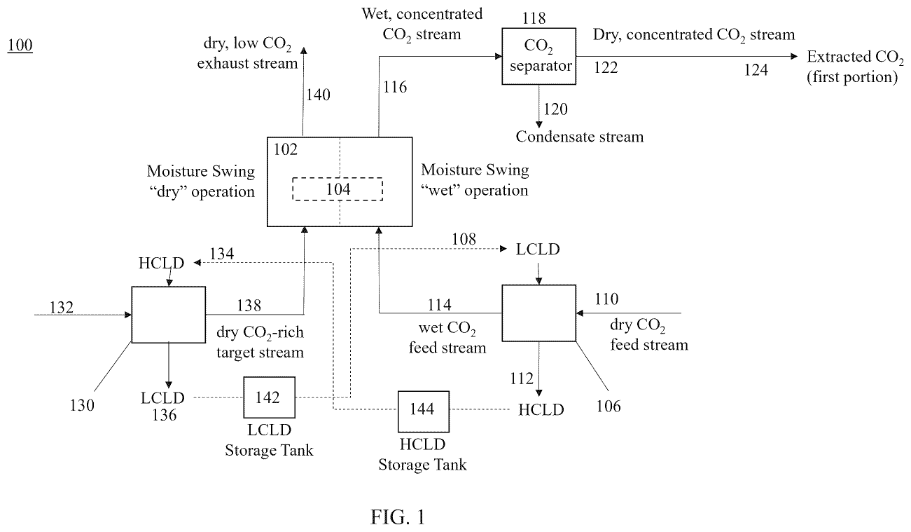

In FIGS. 1-12, like items are indicated by like reference numerals, and for brevity, descriptions of the structure, provided above with reference to the preceding figures, are not repeated.

Referring to FIGS. 1-12, a moisture swing system 100 is disclosed that includes a moisture swing housing 102 comprising a moisture swing material 104, and a liquid desiccant (LD) regenerator 106. The LD regenerator 106 can be adapted to contact a low concentration liquid desiccant (LCLD) stream 108 with a dry CO₂ feed stream 110, where moisture from the LCLD stream 108 is transferred into the CO₂ feed stream 110 as water vapor to form a high concentration liquid desiccant (HCLD) stream 112 and a wet CO₂ feed stream 114. In some embodiments, the LCLD stream 108 and/or dry CO₂ feed stream 110 are heated to drive off water as water vapor from the LCLD stream 108 into the dry CO₂ feed stream 110 to form the wet CO₂ feed stream 114 and the HCLD stream 112. In other embodiments, if the water vapor partial pressure is low enough in the CO₂ feed stream, heating may not be necessary or less heating may be required.

As used herein, “contact” is used to indicate that two streams are able to transfer water, water vapor, or CO₂ from one to the other. In some instances, the contact will be direct, while in other instances the contact will be indirect (e.g., through a membrane).

In some embodiments, the wet CO₂ feed stream 114 is fed into the moisture swing housing 102 to contact the moisture swing material 104 and form a wet, concentrated CO₂ stream 116 that exits the moisture swing housing 102. In some embodiments, the CO₂ from the moisture swing material 104 is released into the wet CO₂ feed stream 114 to form the wet, concentrated CO₂ stream 116.

In some embodiments, the moisture swing system 100 includes a CO₂ separator 118 adapted to convert the wet, concentrated CO₂ stream 116 into a water condensate stream 120 and a dry, concentrated CO₂ stream 122.

In some embodiments, the CO₂ separator 118 comprises a compressor, where the wet, concentrated CO₂ stream 116 is fed into the CO₂ separator 118, and the pressure produced by the compressor causes moisture to condense out of the wet, concentrated CO₂ stream 116 to form a water condensate stream 120 and a dry, concentrated CO₂ stream 122, which exit the CO₂ separator 118. In some embodiments, the CO₂ separator 118 can include a multi-stage compressor, where the wet, concentrated CO₂ stream 116 is cooled between successive compression stages.

In some embodiments, the system does not include a separator 118. In such embodiments, the wet, concentrated CO₂ stream 116 can be the extracted CO₂ stream 124. For example, FIGS. 1, 10, and 11 may be particularly suited for such embodiments.

In some embodiments, as shown in FIG. 1, the dry, concentrated CO₂ stream 122 is removed from the system 100 as an extracted CO₂ stream 124. In some embodiments, a first portion 124 of the dry, concentrated CO₂ stream is removed from the system 100 as an extracted CO₂ stream 124. In some embodiments, as in FIG. 1, the first portion 124 is the entire dry, concentrated CO₂ stream 124. In some such embodiments, the extracted CO₂ stream 124 is injected into the ground for safe, permanent storage of the extracted CO₂.

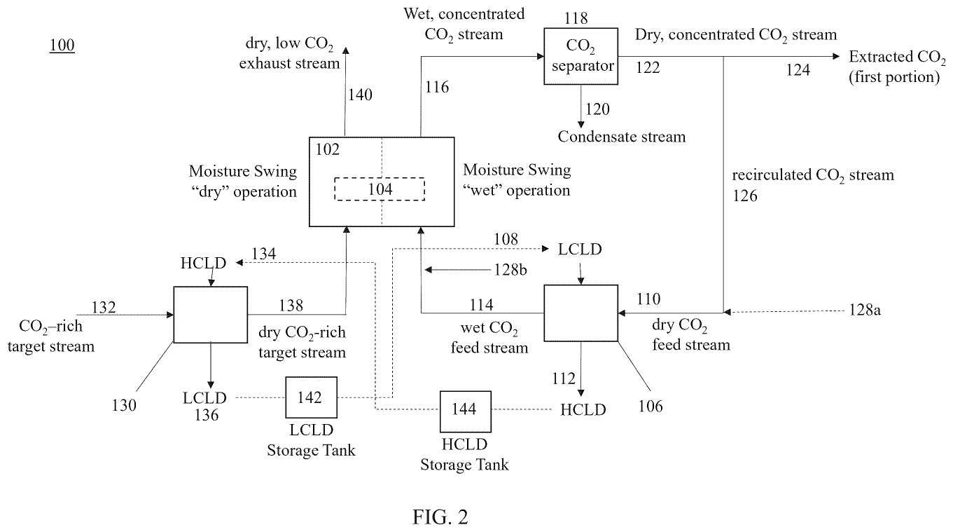

In some embodiments, such as the one shown in FIG. 2, a second portion of the dry, concentrated CO₂ stream 126 is in fluid communication with the liquid desiccant regenerator 106. In some such embodiments, the second portion 126 is a recirculated CO₂ stream and the wet CO₂ feed stream 114 comprises the recirculated CO₂ stream 126. In some embodiments, an enhancement stream 128a is feed into the recirculated CO₂ stream 126 to form the dry CO₂ feed stream 110. In some embodiments, an enhancement stream 128b is feed into the wet CO₂ feed stream 114.

The enhancement stream(s) 128a, 128b can include any of a variety of additives that enhance extraction of CO₂ from the moisture swing material 104. For example, in some embodiments, the enhancement stream(s) 128a, 128b can be used to reduce the partial pressure of CO₂ in the wet CO₂ feed stream 114. In such embodiments, the enhancement stream 128 can include a diluent gas, such as, but not limited to air, nitrogen, oxygen, argon, helium, and xenon.

In some embodiments, the moisture swing system 100 includes a liquid desiccant (LD) conditioner 130 adapted to contact a CO₂-rich target stream 132 with a high concentration liquid desiccant (HCLD) stream 134. In such embodiments, moisture from the CO₂-rich target stream 132 is absorbed by the HCLD stream 134 to form a low concentration liquid desiccant (LCLD) stream 136 and a dry CO₂-rich target stream 138. In some embodiments, the dry CO₂-rich target stream 138 is fed into the moisture swing housing 102 to contact the moisture swing material 104 and form a dry, low CO₂ exhaust stream 140 that exits the moisture swing housing 102. In such embodiments, CO₂ from the dry CO₂-rich target stream 138 is adsorbed by the moisture swing material 104, and the dry, low CO₂ exhaust stream 140 has a reduced concentration of CO₂ compared to the CO₂-rich target stream 132. The dry, low CO₂ exhaust stream 140 can then be released into the atmosphere with less CO₂. In some embodiments, the CO₂-rich target stream 132 can be air from the atmosphere or exhaust from an industrial process that produces CO₂. In this manner, the amount of greenhouse gas in the environment can be reduced.

In some embodiments, the HCLD stream 112 exiting the LD regenerator 106 is in fluid communication with the HCLD stream 134 fed into the LD conditioner 103. In some embodiments, the LCLD stream 136 exiting the LD conditioner 130 is in fluid communication with the LCLD stream 108 fed into the LD regenerator 106. In some embodiments, as shown in the dashed lines of FIG. 2, the liquid desiccant used in the LC conditioner 130 and the LD regenerator is part of a closed loop.

In some embodiments, the LCLD stream 136 feeds into a LCLD storage tank 142, which supplies the LCLD stream 108 fed into the LD regenerator 106. In some embodiments, the HCLD stream 112 feeds into a HCLD tank 144, which supplies the HCLD stream 134 fed into the LD conditioner 130.

In some embodiments, operation of the LD regenerator 106 can be energy intensive. In some embodiments, the moisture swing system 100 can be used in a batch-wise manner. The use of tanks 142, 144 allows for the LD regenerator 106 to be operated during off-peak hours (e.g., overnight). In particular, if the dry CO₂-fixing operation occurs during peak hours, the resulting LCLD stream 136 can be stored in the LCLD tank 142. Then, during the off-peak hours, the LCLD stream 108 can be fed into the LD regenerator 106 to produce the HCLD stream 112, which can be stored in the HCLD tank 144 until it is needed. In this way, the energy consumption is moved to off-peak hours.

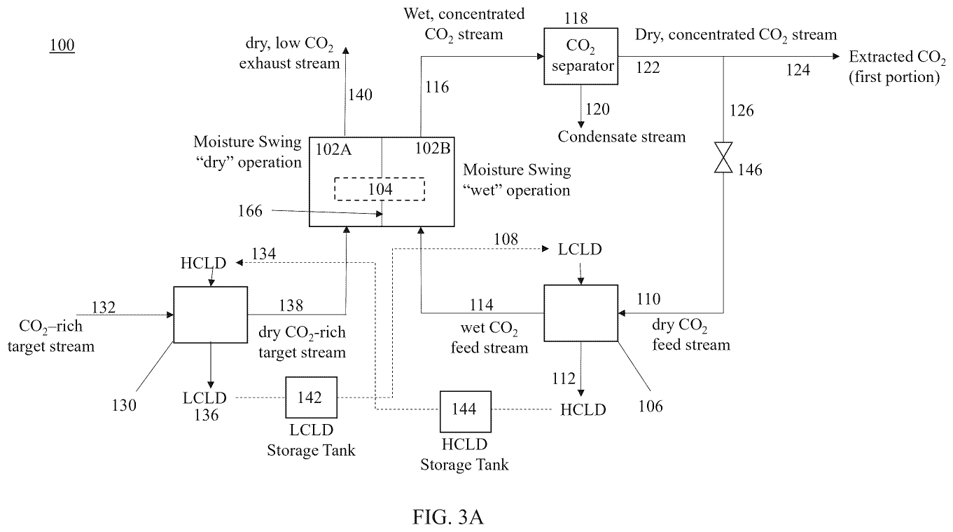

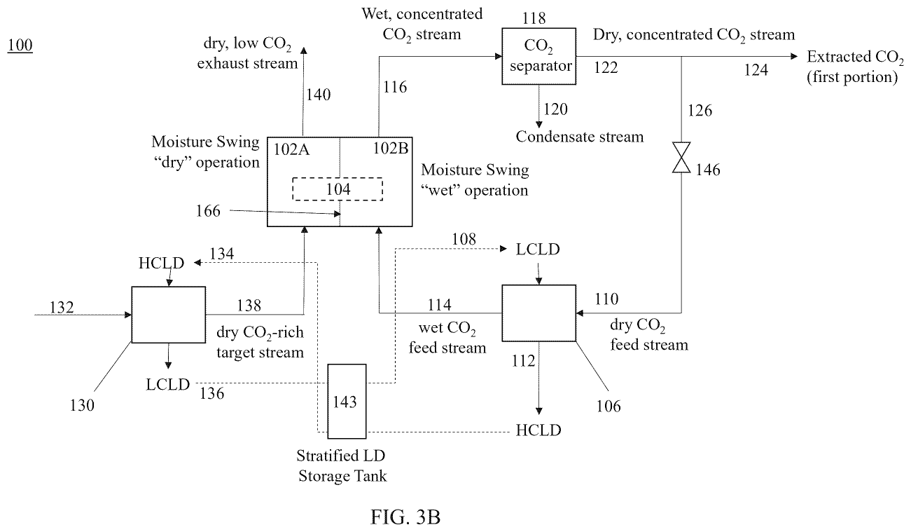

In some embodiments, as shown in FIGS. 3A and 3B, the moisture swing system 100 comprises a valve 146, where the second portion of the dry-concentrated CO₂ stream 126 flows through the valve 146 before entering the liquid desiccant regenerator 106. In some embodiments, the dry CO₂ feed stream 110, the wet CO₂ feed stream 114, the moisture swing housing 102, and the wet, concentrated CO₂ stream 116 are all at reduced pressure. In some embodiments, the dry, concentrated CO₂ stream 122 exiting the CO₂ separator 118 is at high pressure. In some embodiments, the valve 146 is adapted for reducing pressure of the stream flowing through the valve 146. For example, in some embodiments, the valve 146 is selected from an expansion valve.

In some embodiments, the pressure of the CO₂ stream 110/114 in the LD regenerator 106 is less than 1000 mbar. In some embodiments, the pressure of the CO₂ stream 110/114 in the LD regenerator 106 is less than 750 mbar, or less than 500 mbar, or less than 250 mbar, or less than 100 mbar, or less than 50 mbar, or less than 40 mbar, or less than 30 mbar, or less than 20 mbar.

In some embodiments, the wet CO₂ feed stream 114 is at a reduced pressure when it contacts the moisture swing material 104. In some embodiments, the total pressure of the CO₂ stream 114/116 in the moisture swing housing 102 is less than 1000 mbar. In some embodiments, the total pressure of the CO₂ stream 114/116 in the moisture swing housing 102 is less than 750 mbar, or less than 500 mbar, or less than 250 mbar, or less than 100 mbar, or less than 50 mbar, or less than 40 mbar, or less than 30 mbar, or less than 20 mbar. For clarity, unless specified otherwise, these pressures relate to the total pressure of the applicable stream, not a partial pressure of a particular component.

In some embodiments, the CO₂ separator 118 comprises a vacuum to reduce pressure in the dry CO₂ feed stream 110, the wet CO₂ feed stream 114, the moisture swing housing 102, and the wet, concentrated CO₂ stream 116.

In some embodiments, the amount of CO₂ the wet CO₂ feed stream 114 picks up from the moisture swing material 104 is discharged in the extracted CO₂ stream 124.

In some embodiments, as shown in FIG. 3B, the LCLD storage tank 142 and the HCLD storage tank 144 can be replaced by a stratified LD storage tank 143. In the stratified LD storage tank 143, the HCLD and LCLD can be separated based on their differences in density. Thus, the HCLD will generally settle to the bottom of the tank 143, while the LCLD will rise to the top of the tank 143. The halocline can be maintained by feeding and removing HCLD from the bottom of the tank 143, and feeding and removing HCLD from the top of the tank 143.

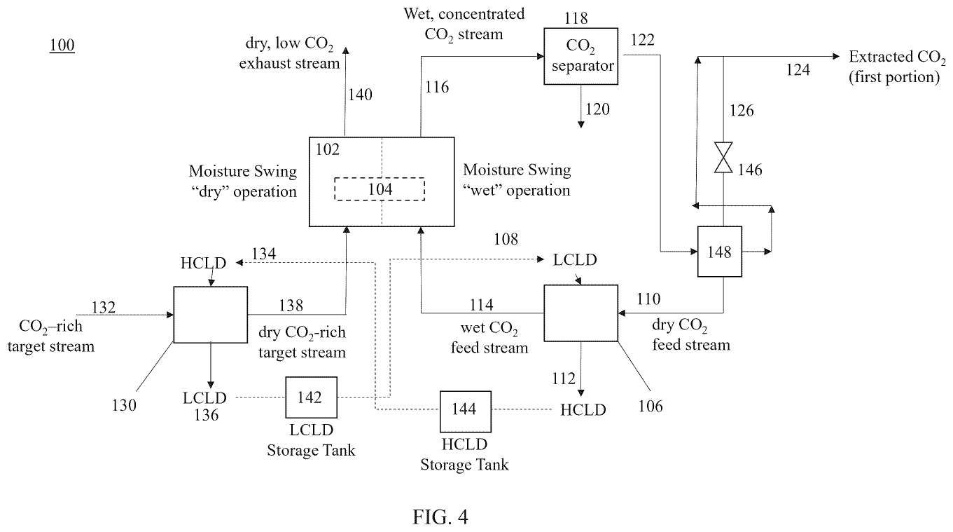

In some embodiments, as shown in FIG. 4, the moisture swing system 100 includes a heat exchanger 148 adapted to heat the dry CO₂ feed stream 110 prior to entering the LD regenerator 106. As will be understood, after undergoing the pressurizing process in the CO₂ separator 118, the dry, concentrated CO₂ stream 122 will be heated relative to the wet, concentrated CO₂ stream 116 entering the CO₂ separator 118, as well as, relative to the dry CO₂ feed stream exiting the valve 146. In some embodiments, the dry, concentrated CO₂ stream 122 can be fed into the heat exchanger 148 to heat the dry CO₂ feed stream 110.

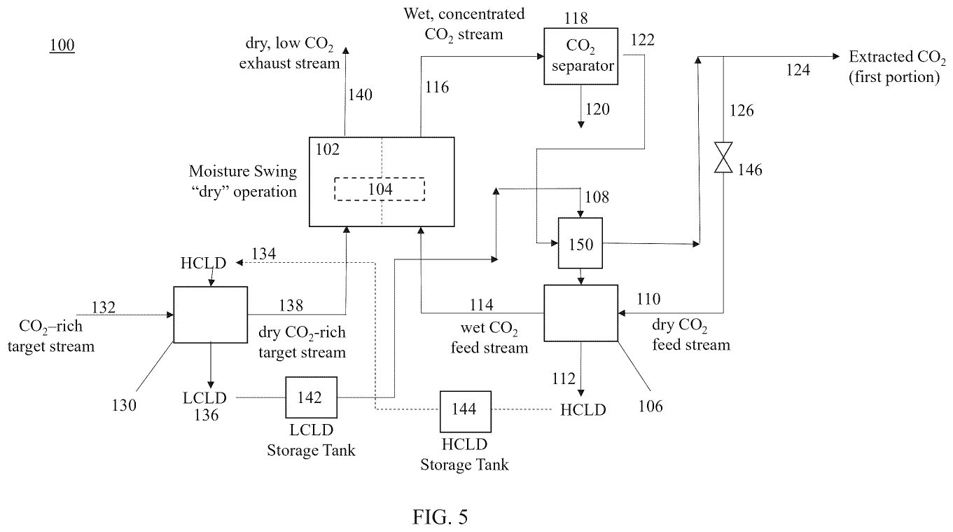

In some embodiments, as shown in FIG. 5, the moisture swing system 100 includes a heat exchanger 150 adapted to heat the LCLD stream 108 prior to entering the LD regenerator 106. In some embodiments, the dry, concentrated CO₂ stream 122 can be fed into the heat exchanger 150 to heat the LCLD stream 108.

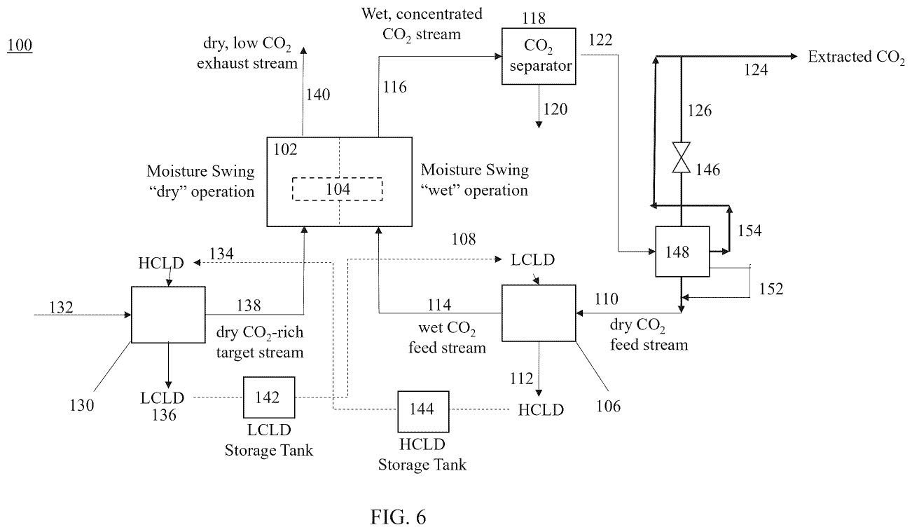

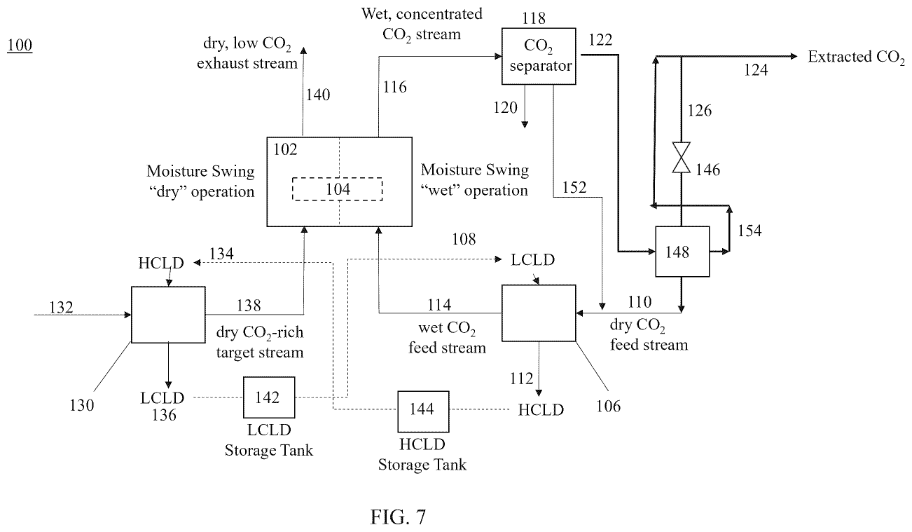

In some embodiments, such as those in FIGS. 6 and 7, the LD regenerator 106 loop portion of the system can include a diluent. In some embodiments, the diluent can be present in the dry CO₂ feed stream 110, the wet CO₂ feed stream 114, the wet-concentrated CO₂ stream, and the dry, concentrated CO₂ stream 122. In some embodiments, the extracted CO₂ stream does not include any diluent. In some embodiments, such as those in FIGS. 6 and 7, the heavy lines of streams 124, 126, and 154 represent streams that do not include any diluent.

In some embodiments, as shown in FIG. 6, the diluent condensed in the CO₂ heat exchanger 148 exits as a diluent stream 152 that is fed into the dry CO₂ feed stream 110 prior to being fed into the LD regenerator 106. In some embodiments, as shown in FIG. 7, the diluent is condensed in the CO₂ separator 118 and exits as a diluent stream 152 that is fed into the dry CO₂ feed stream 110 prior to being fed into the LD regenerator 106.

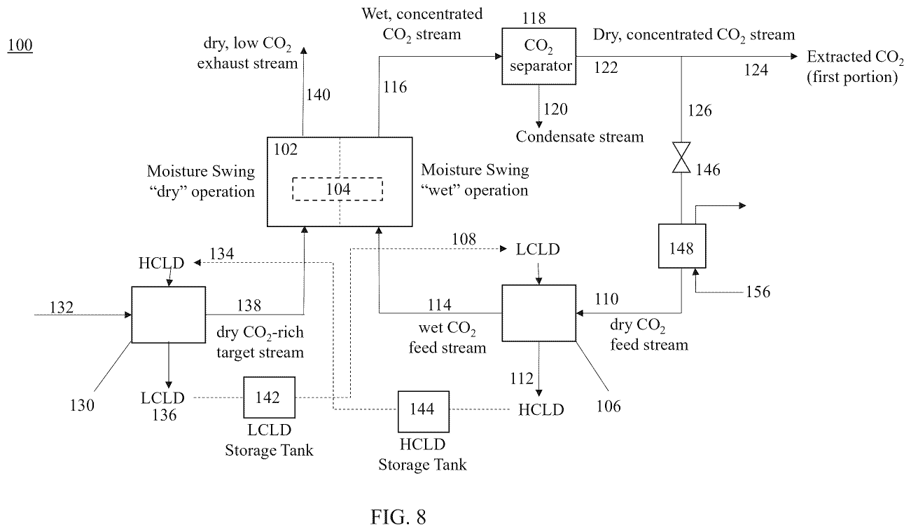

In some embodiments, as shown in FIG. 8, a heating stream 156 used in the CO₂ heat exchanger 148 is from an external source. In some embodiments, the heating stream 156 can be ambient air. In some embodiments, the heating stream 156 can be another fluid, such as, but not limited to, water, glycol solutions, argon, propane, CO₂, fluorocarbons, liquid desiccant solutions, or oils.

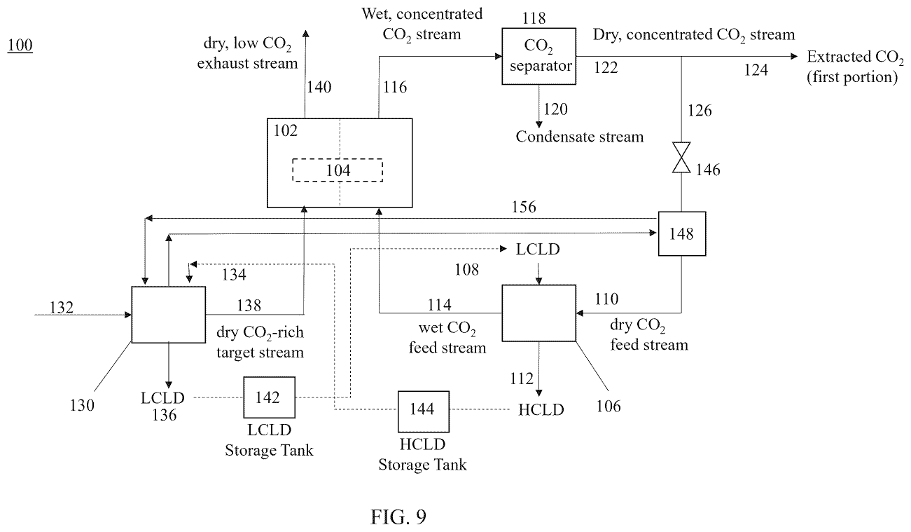

In some embodiments, as shown in FIG. 9, the heating stream 156 used in the CO₂ heat exchanger 148 can be used to cool the LD conditioner 130, while heating the dry CO₂ feed stream 110. In some embodiments, the heating stream 156 can be a refrigerant, such as, but not limited to, water, glycol solutions, argon, propane, CO₂, fluorocarbons, liquid desiccant solutions, or oils.

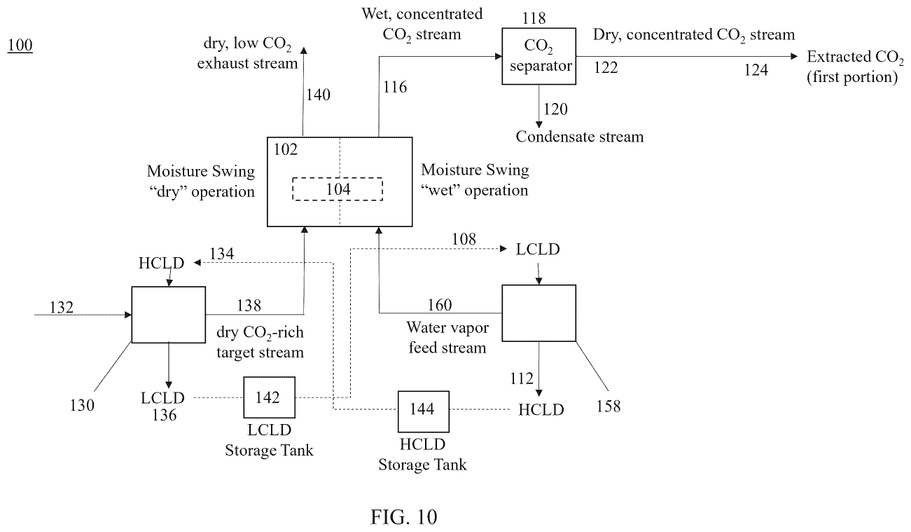

In some embodiments, as shown in FIG. 10, there is no CO₂ recirculation. Rather, a boiling regenerator 158 is used to convert the LCLD stream 108 into a HCLD stream 112. The boiling regenerator 158 produces a water vapor feed stream 160, which is fed into the moisture swing housing 102 and contacts the moisture swing material 104. The remainder of the system is as described in FIG. 1.

In any of the embodiments disclosed herein, the dual storage tanks 142, 144 can be replaced with the stratified LD storage tank 143 described in FIG. 3B.

In some embodiments, as described above, the moisture swing housing 102 and the wet, concentrated CO₂ stream 116 can be maintained at reduced pressure. In some embodiments, the pressure of the water vapor feed stream 160 in the moisture swing housing 102 is less than 1000 mbar. In some embodiments, the pressure of the water vapor feed stream 160 in the moisture swing housing 102 is less than 750 mbar, or less than 500 mbar, or less than 250 mbar, or less than 100 mbar, or less than 50 mbar, or less than 40 mbar, or less than 30 mbar, or less than 20 mbar.

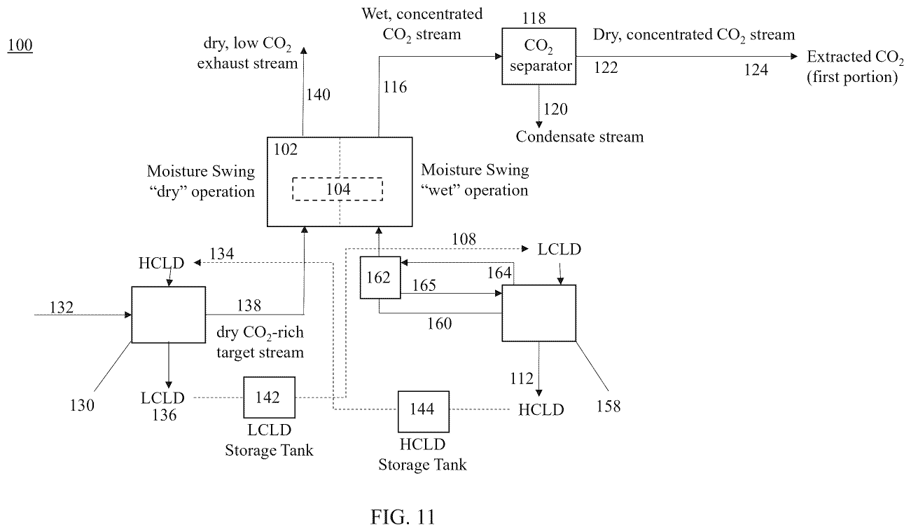

In some embodiments of FIGS. 10 and 11, the CO₂ separator 118 comprises a vacuum to reduce pressure in the water vapor feed stream 160, the moisture swing housing 102, and the wet, concentrated CO₂ stream 116. In some embodiments, the CO₂ separator 118 can include a compressor of increase pressure therein. Thus, the CO₂ separator 118 can eliminate water vapor from the wet, concentrated CO₂ stream 116. As described previously, this produces the condensate stream 120 and the dry, concentrated CO₂ stream 122.

In some embodiments, as shown in FIG. 11, the system 100 can include a moisture swing pre-heater 162. The moisture swing pre-heater 162 can be adapted to heat the water vapor feed stream 160 prior to entering the moisture swing housing 102. A hot refrigerant stream 164 from the boiling regenerator 158 can be fed to the moisture swing pre-heater 162. In some embodiments, after exiting the moisture swing pre-heater 162, the cool refrigerant stream 165 can return to the boiling regenerator 158, where it is heated to form the hot refrigerant stream 164.

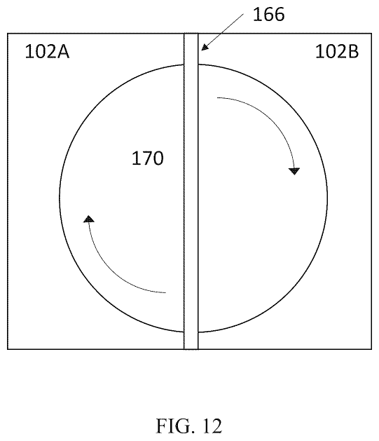

In some embodiments, as shown in FIGS. 3 and 12, the moisture swing housing 102 is divided into two parts: a dry side 102A and a wet side 102B. This optional dividing wall 166 is represented by the dashed line in the moisture swing housing 102.

In some embodiments, the moisture swing system 100 is operated in a batch-wise manner. For example, the dry subsystem that deposits CO₂ in or on the moisture swing material 104 is operated for a specified period of time. Then, the CO₂ deposition subsystem is turned off and the wet CO₂ removal subsystem is turned on. The wet CO₂ removal subsystem supplies the wet CO₂ feed stream 114 or the water vapor feed stream 160 to the moisture swing housing 102 in order to remove CO₂ from the moisture swing material 104. As will be understood, the CO₂-depositing step requires a dry environment, while removing CO₂ requires a moist environment. Thus, a batch-wise approach can be helpful in some embodiments. In some such embodiments, no dividing wall would be required in the moisture swing housing 102.

In some embodiments, the dividing wall 166 is present in the moisture swing housing 102. In such embodiments, as shown in FIGS. 3A and 3B, the moisture swing housing 102 comprises a dry side 102A and a wet side 102B. In such embodiments, the wet CO₂ stream 114 is fed into the wet side 102B of the moisture swing housing 102, and the dry CO₂-rich target stream 138 is fed into the dry side 102A of the moisture swing housing 102.

In embodiments that include a dry side 102A and a wet side 102B, part of the moisture swing material 104 is exposed to the dry side 102A, while another part of the moisture swing material 104 is exposed to the wet side 102B. In some embodiments, the dry side 102A and the wet side 102B are used simultaneously. In some such embodiments, as shown in FIG. 12, the moisture swing material 104 can be incorporated into a rotating plate 170, where a portion of the rotating plate 170 is present in the dry side 102A and another portion of the rotating plate 170 is present in the wet side 102A. For example, as shown in FIG. 12, the axis of rotation of the rotating plate 170 can be aligned with the dividing wall 166. The shape of the rotating plate 170 can be any appropriate shape including, but not limited to, circle, square, rectangle, hexagon, etc.

In some embodiments, the dry side 102A and the wet side 102B are used in a batch-wise manner. In some such embodiments, the dry CO₂-rich target stream 138 is contacted with the moisture swing material 104 for a period of time, then the wet CO₂ stream 114 or water vapor feed stream 160 is contacted with the moisture swing material 104.

Although the subject matter has been described in terms of exemplary embodiments, it is not limited thereto. Rather, the appended claims should be construed broadly, to include other variants and embodiments, which may be made by those skilled in the art.

What is claimed is:

1. A moisture swing system, comprising:
a moisture swing housing comprising a moisture swing material; and
a liquid desiccant (LD) regenerator adapted to contact a low concentration liquid desiccant (LCLD) stream with a dry CO₂ feed stream, wherein moisture from the LCLD stream is transferred into the CO₂ feed stream as water vapor to form a high concentration liquid desiccant (HCLD) stream and a wet CO₂ feed stream,
wherein the wet CO₂ stream is fed into the moisture swing housing to contact the moisture swing material and form a wet, concentrated CO₂ stream that exits the moisture swing housing.

2. The moisture swing system of claim 1, further comprising a CO₂ separator adapted to convert the wet, concentrated CO₂ stream into a water condensate stream and a dry, concentrated CO₂ stream.

3. The moisture swing system of claim 2, wherein the CO₂ separator comprises a compressor, wherein the wet, concentrated CO₂ stream is fed into the CO₂ separator, wherein pressure produced by the compressor causes moisture to condense out of the wet, concentrated CO₂ stream and form the water condensate stream and the dry, concentrated CO₂ stream.

4. The moisture swing system of claim 1, wherein a first portion of the dry, concentrated CO₂ stream is removed from the system as an extracted CO₂ stream.

5. The moisture swing system of claim 4, wherein a second portion of the dry, concentrated CO₂ stream is in fluid communication with the liquid desiccant regenerator, wherein the wet CO₂ feed stream comprises the second portion of the dry concentrated CO₂ stream.

6. The moisture swing system of claim 5, further comprising a valve, wherein the second portion of the dry-concentrated CO₂ stream flows through the expansion valve before entering the liquid desiccant regenerator.

7. The moisture swing system of claim 6, wherein the wet CO₂ feed stream is at a reduced pressure when it contacts the moisture swing material.

8. The moisture swing system of claim 1, further comprising a heat exchanger adapted to heat the LCLD stream before it is fed into the liquid desiccant regenerator.

9. The moisture swing system of claim 1, wherein CO₂ from the moisture swing material is released into the wet CO₂ feed stream to form the wet, concentrated CO₂ stream.

10. The moisture swing system of claim 1, further comprising a liquid desiccant (LD) conditioner adapted to contact a CO₂-rich target stream with a high concentration liquid desiccant (HCLD) stream, wherein moisture from the CO₂-rich target stream is absorbed by the HCLD stream to form a low concentration liquid desiccant (LCLD) stream and a dry CO₂-rich target stream,
wherein the dry CO₂-rich target stream is fed into the moisture swing housing to contact the moisture swing material and form a dry, low CO₂ exhaust stream that exits the moisture swing housing.

11. The moisture swing system of claim 10, wherein CO₂ from the dry CO₂-rich target stream is adsorbed by the moisture swing material.

12. The moisture swing system of claim 10, wherein the HCLD stream exiting the LD regenerator is in fluid communication with the HCLD stream fed into the LD conditioner, and
wherein the LCLD stream exiting the LD conditioner is in fluid communication with the LCLD stream fed into the LD regenerator.

13. The moisture swing system of claim 10, wherein the moisture swing housing comprises a wet side and a dry side, wherein the wet CO₂ stream is fed into the wet side of the moisture swing housing, and the dry CO₂-rich target stream is fed into the dry side of the moisture swing housing.

14. The moisture swing system of claim 10, wherein the dry CO₂-rich target stream is contacted with the moisture swing material, then the wet CO₂ stream is contacted with the moisture swing material in a batch-wise manner.

15. A moisture swing system, comprising
a moisture swing housing comprising a moisture swing material; and
a liquid desiccant (LD) conditioner adapted to contact a CO₂-rich target stream with a high concentration liquid desiccant (HCLD) stream, wherein moisture from the CO₂-rich target stream is absorbed by the HCLD stream to form a low concentration liquid desiccant (LCLD) stream and a dry CO₂-rich target stream,
wherein the dry CO₂-rich target stream is fed into the moisture swing housing to contact the moisture swing material and form a dry, low CO₂ exhaust stream that exits the moisture swing housing.

16. The moisture swing system of claim 15, further comprising a liquid desiccant (LD) regenerator adapted to contact a low concentration liquid desiccant (LCLD) stream with a dry CO₂ feed stream, wherein moisture from the LCLD stream is transferred into the CO₂ feed stream as water vapor to form a high concentration liquid desiccant (HCLD) stream and a wet CO₂ feed stream;
wherein the wet CO₂ stream is fed into the moisture swing housing to contact the moisture swing material and form a wet, concentrated CO₂ stream that exits the moisture swing housing;
wherein the HCLD stream exiting the LD regenerator is in fluid communication with the HCLD stream fed into the LD conditioner, and
wherein the LCLD stream exiting the LD conditioner is in fluid communication with the LCLD stream fed into the LD regenerator.

17. A moisture swing system, comprising:
a moisture swing housing comprising a moisture swing material; and
a boiling regenerator adapted to produce a water vapor feed stream, while converting a low concentration liquid desiccant stream into a high concentration liquid desiccant stream,
wherein the water vapor feed stream is fed into the moisture swing housing to contact the moisture swing material and form a wet, concentrated CO₂ stream that exits the moisture swing housing.

18. The moisture swing system of claim 17, further comprising a CO₂ separator adapted to convert the wet, concentrated CO₂ stream into a water condensate stream and a dry, concentrated CO₂ stream.

19. The moisture swing system of claim 17, further comprising a liquid desiccant (LD) conditioner adapted to contact a CO₂-rich target stream with a high concentration liquid desiccant (HCLD) stream, wherein moisture from the CO₂-rich target stream is absorbed by the HCLD stream to form a low concentration liquid desiccant (LCLD) stream and a dry CO₂-rich target stream,
wherein the dry CO₂-rich target stream is fed into the moisture swing housing to contact the moisture swing material and form a dry, low CO₂ exhaust stream that exits the moisture swing housing.

20. The moisture swing system of claim 19, wherein the HCLD stream exiting the boiling regenerator is in fluid communication with the HCLD stream fed into the LD conditioner, and
wherein the LCLD stream exiting the LD conditioner is in fluid communication with the LCLD stream fed into the boiling regenerator.
